(19) United States
(12) Patent Application Publication
(10) Pub. No.: US 2010/0082377 A1
(43) Pub. Date: Apr. 1, 2010

(54) Risk Evaluation of Conflicts in Separation of Duties

(75) Inventors: Satoshi Hada, Machida-shi (JP); Hiroaki Ozeki, Yamato-shi (JP)

Correspondence Address: DUKE W. YEE;YEE & ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/239,135

(22) Filed: Sep. 26, 2008

(51) Int. Cl. G06Q 10/00

(52) U.S. Cl. 705/7

(57) ABSTRACT

In one embodiment, there is provided a computer implemented method for evaluating risks of conflicts in separation of duties matrices. The computer implemented method receives a set of input data comprising a set of task information and a set of employee information to form received input, generates a risk control matrix from the received input, having a risk associated with each risk control of the risk control matrix, and generates an “n×n” weighted separation of duties matrix from the risk control matrix, wherein (Ti,Tj) represents a task pair, and Risk(Ti,Tj) represents a risk value of a conflict of the task pair (Ti,Tj). The computer implemented method further generates a task to employee assignment (p1, p2, p3 . . . pk) such that Σ{1≦x≦k}Σ{(Ti,Tj)εpx} Risk(Ti,Tj) is minimized. The first summation is formed over variable x, from 1 through k, while the second summation is formed over task pairs (Tᵢ, Tⱼ) in the assignment px, which is the task set assigned to employee “x.” In the expression, “k” represents the number of employees, and “pi” represents a set of tasks assigned to employee “i”. The computer implemented method identifies elements of high risk in the “n×n” weighted separation of duties matrix; to form identified elements and samples the identified elements to form sampled elements. The computer implemented method further determines whether the sampled elements identify a risk exposure; and responsive to a determination that the sampled elements identify a risk exposure, reports a finding of the risk exposure.

### BACKGROUND OF THE INVENTION

1. Field of the Invention

The present invention relates generally to an improved data processing system and more specifically to a computer implemented method, a data processing system, and a computer program product for risk evaluation of conflicts in separation of duties.

2. Description of the Related Art

Separation of duties (SoD) is typical means for the prevention of internal fraud in companies. For example, in the process of reimbursement of company expenses, such as travel expenses, the actions of requesting of the reimbursement and the verification of the receipts should be performed by different employees. An employee should not be allowed to submit and approve their own expenses.

Similar separation of duties is required for a range of in-company processes such as sales, purchasing, inventory control, accounting, and personnel matters. Separation of duties is considered a fundamental aspect of implementing internal control. Various tools which continuously monitor whether separation of duties is being observed adequately have been introduced commercially. For example, separation of duties tools may be found within enterprise resource planning (ERP) software products.

Typical commercial products, express the constraints of separation of duties as a symmetric matrix that may be referred to as a separation of duties matrix. With reference to FIG. 3, an example of a separation of duties matrix 300 is provided and shows a set of three tasks. Vertical axis 302 defines the three set of tasks and horizontal axis 304 also defines the same set of tasks, while cells indicate possible combinations. In this example, the symbol “x” identifies a conflict, indicating the corresponding pair of tasks must be performed by different employees to meet the requirements of a separation of duties. The example of conflict 306 indicates that tasks A and B must be performed by different employees, and at the same time, conflict 308 indicates tasks A and C must be performed by different employees.

The enterprise resource planning (ERP) products typically provide a capability to define separation of duties matrices, as well as monitor for violations in each conflict defined. Violations are typically determined by checking the relationships in the matrices against access control policies and logs. If a violation is found, a report is generated for review by an assigned person.

Using the described products (and having the separation of duties matrices defined adequately) typically leaves the problem of employee staffing shortages and sampling the violations. The problem of dealing with the shortage of employees may be related to a small office setting, in which the number of employees is not sufficient to observe separation of duties. For example, for the matrix shown in FIG. 1, at least two employees are required. If there is only one employee, separation of duties cannot occur and be observed. However, in many companies, there are no guidelines as to how employees should be assigned to tasks if there is a shortage of employees.

Sampling checks for conflict violations. In the actual system, an extremely large number of conflict violations, such as conflict 306 and conflict 308, are reported for a variety of reasons. In such cases, actions to be taken against the reported conflict violations need to be devised, such as determining their causes. When there are an extremely large number of reports, close investigation of every conflict is impossible, and thus, a need arises for some form of sampling to be performed. However, in many companies, there are no guidelines as to how the sampling should be performed. A solution to this, as well as the previous problem of defining separation of duties in short staff situations, would be desirable.

### BRIEF SUMMARY OF THE INVENTION

According to one embodiment of the present invention, there is provided a computer implemented method for evaluating risks of conflicts in separation of duties matrices. The computer implemented method receives a set of input data comprising a set of task information and a set of employee information to form received input, generates a risk control matrix from the received input, having a risk associated with each risk control of the risk control matrix, and generates an “n×n” weighted separation of duties matrix from the risk control matrix, wherein (Ti,Tj) represents a task pair, and Risk(Ti,Tj) represents a risk value of the conflict of the task pair (Ti,Tj). The computer implemented method further generates a task to employee assignment (p1, p2, p3 . . . pk) such that Σ{1≦x≦k}Σ{(Ti,Tj)εpx} Risk(Ti,Tj) is minimized. In the expression, “k” represents the number of employees, and “pi” represents a set of tasks assigned to employee “i.” The first summation is formed over variable x, from 1 through k, while the second summation is formed over task pairs (Tᵢ, Tⱼ) in the assignment px, which is the task set assigned to employee “x.”

The computer implemented method further identifies elements of high risk in the “n×n” weighted separation of duties matrix; to form identified elements and samples the identified elements to form sampled elements. The computer implemented method further determines whether the sampled elements identify a risk exposure, and responsive to a determination that the sampled elements identify a risk exposure, reports a finding of the risk exposure.

### BRIEF DESCRIPTION OF THE SEVERAL VIEWS OF THE DRAWINGS

FIG. 1 depicts a pictorial representation of a network of data processing system in which illustrative embodiments may be implemented;

FIG. 2 is a block diagram of a data processing system in which illustrative embodiments may be implemented;

FIG. 3 is a tabular view of a separation of duties matrix in typical practice;

FIG. 4 is a block diagram of components of a risk controller in accordance with illustrative embodiments;

FIG. 5 is a block diagram of high-level overview of a risk controller process, in accordance with illustrative embodiments;

FIG. 6 is a block diagram of an example of a payroll process, in accordance with illustrative embodiments;

FIG. 7 is a tabular view of a risk control matrix in accordance with illustrative embodiments;

FIG. 8 is a tabular view of an adjusted separation of duties matrix, in accordance with illustrative embodiments; and

FIG. 9 is a flowchart of a process of defining an adjusted separation of duties matrix, in accordance with illustrative embodiments.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wire line, optical fiber cable, RF, etc.

Computer program code for carrying out operations of the present invention may be written in any combination of one or more programming languages, including an object-oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus, to produce a machine, such that the instructions, which execute via the processor of the computer, or other programmable data processing apparatus, create means for implementing the functions/acts specified in the flowchart and/or block diagram block or blocks. These computer program instructions may also be stored in a computer-readable medium that can direct a computer, or other programmable data processing apparatus, to function in a particular manner, such that the instructions stored in the computer-readable medium produce an article of manufacture including instruction means which implement the function/act specified in the flowchart and/or block diagram block or blocks.

The computer program instructions may also be loaded onto a computer, or other programmable data processing apparatus, to cause a series of operational steps to be performed on the computer, or other programmable apparatus, to produce a computer implemented process such that the instructions which execute on the computer, or other programmable apparatus, provide processes for implementing the functions/acts specified in the flowchart and/or block diagram block or blocks.

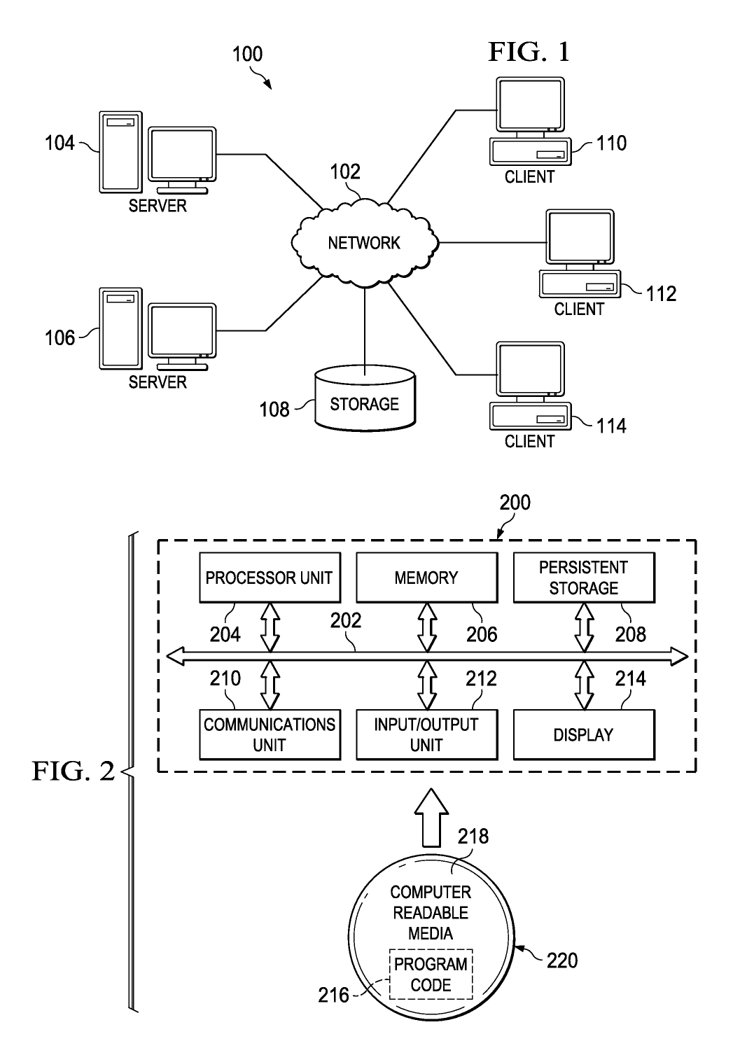

With reference now to the figures, and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing system, in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102, along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

Using the example of system 100 of FIG. 1, users on client 110, client 112 and client 114 may be connected to a risk management system on server 104 through network 102. An adjusted separation of duties matrix may exist of server 104 as a means of monitoring and controlling actions of the users. For example, a risk determination is calculated for an action in which the users are involved, and applied to form an adjusted separation of duties. The risk determination applied to the separation of duties forms an adjusted separation of duties. The adjusted matrix may then be used to determine a risk associated with a set of assigned tasks to identify minimum risks under less than optimal conditions. For example, the risk adjusted separation of duties matrix provides a capability to determine which separation scenario to pick when a staffing shortage affecting a task occurs, such as when the user on client 114 is absent.

With reference now to FIG. 2, a block diagram of a data processing system is shown, in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors, or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-readable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

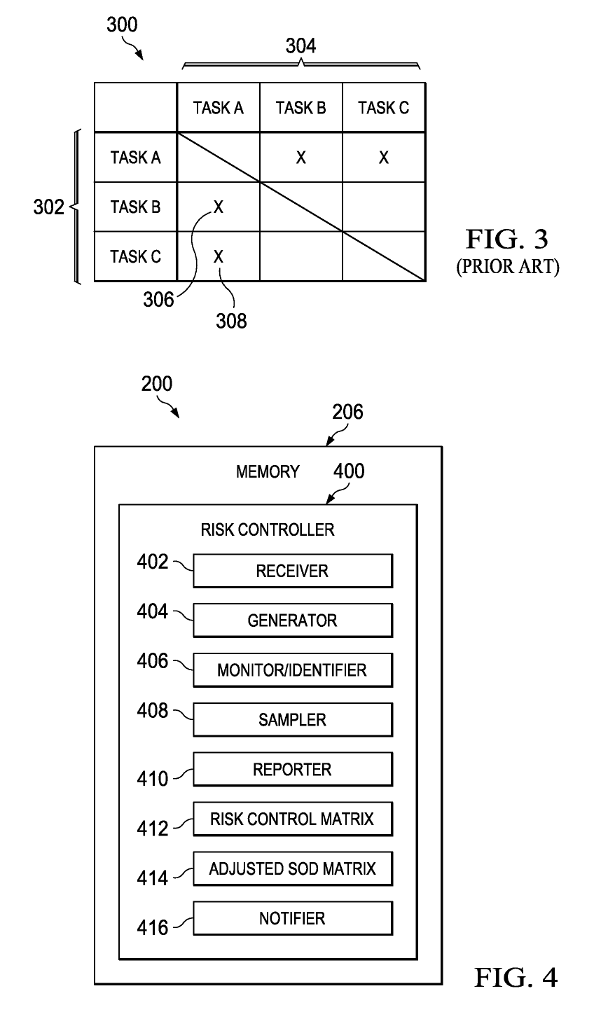

With reference to FIG. 3, a tabular view of a separation of duties matrix in typical practice is shown. Separation of duties matrix 300 represents the relationship between three tasks. Vertical axis 302 identifies a set of tasks A, B and C. In a similar manner, horizontal axis 304 identifies the same set of tasks. Conflict 306 identifies a relationship of task A with task B, while conflict 308 identifies a relationship of task A with task C, indicating that these task pairs cannot be performed by the same person, and there should thus be a separation of duties.

With reference to FIG. 4, a block diagram of components of a risk controller, in accordance with illustrative embodiments, is shown. Risk controller 400 is shown within memory 206 of system 200 of FIG. 2. Risk controller 400 may also be located within other memory locations of system 200, such as persistent storage 208, until needed in operation, or in computer-readable media 218 until installed for later use.

Risk controller 400 contains a set of components comprising receiver 402, generator 404, monitor/identifier 406, sampler 408, reporter 410, risk control matrix 412, adjusted separation of duties matrix 414 and notifier 416. Together, the components provide a capability to create and manage a set of risk adjusted separation of duties. Receiver 402 provides a capability to obtain input from a user, or other component, providing information for the establishment of a risk associated with a task combination.

Generator 404 provides a capability to create risk control matrix 412 and adjusted separation of duties matrix 414. Adjusted separation of duties matrix 414 uses input from risk control matrix 412 to modify or adjust the task assignments, and provide an indication of the risk associated with a specific task combination.

Monitor/identifier 406 provides a capability to track and identify events that do not correspond to the stated goals in adjusted separation of duties matrix 414. The action taken is typically in the form of a notification through notifier 416. Notifier 416 may be a stub into an existing system providing a user interface component, a complete messaging service, or other suitable tool.

Sampler 408 is a utility that provides a service of sampling a specified set of alerts created from actions of monitor/identifier 406. Sampler 408 may be used to investigate a subset of the alerts created by conflict violations, as determined by the monitoring system.

Reporter 410 creates a set of output reports for use by a system administrator, or other appropriate people, interested in resolving conflicts found. Reports may be viewed, printed, saved, or sent for further review.

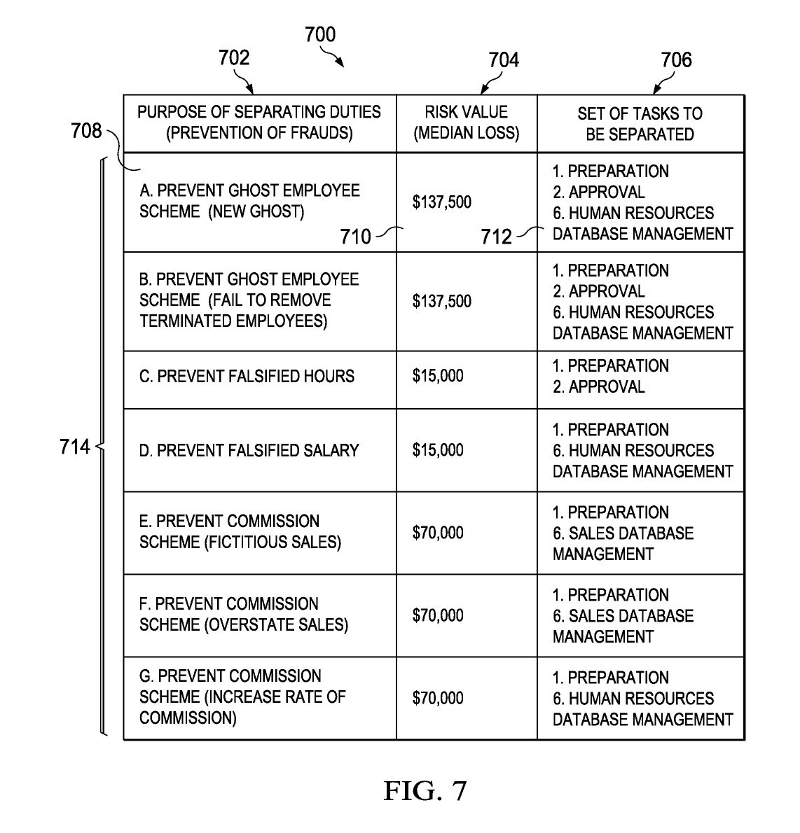

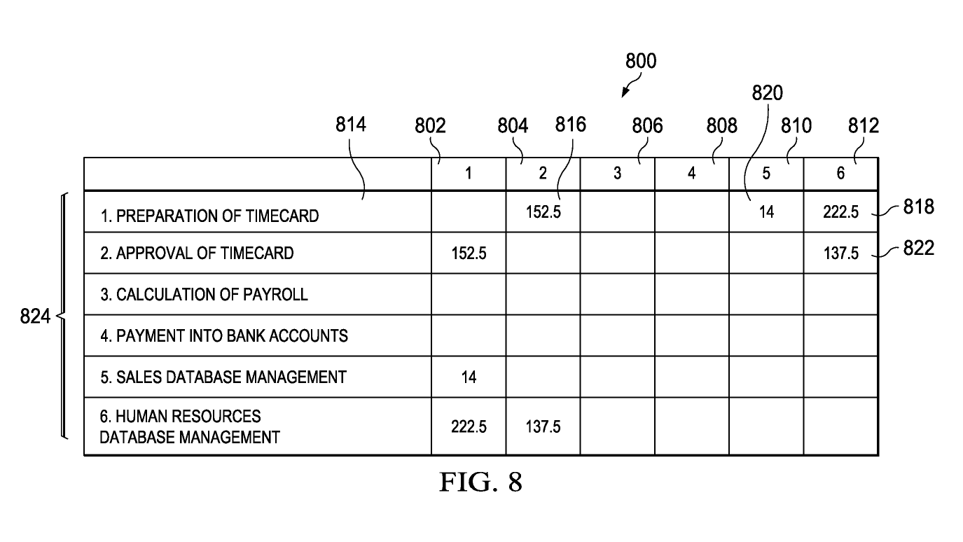

Risk control matrix 412 is an array in which potential risk has been attributed to specified business processes and controls for dealing with identified risks. An example is provided in FIG. 7. Adjusted separation of duties matrix 414 is a typical separation of duties matrix to which has been applied the potential risk assignments, as shown in FIG. 8.

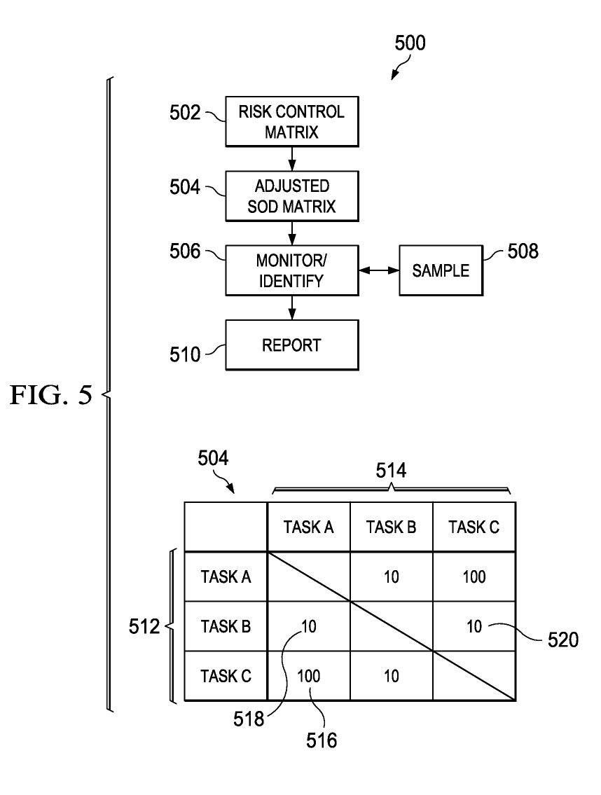

With reference to FIG. 5, a block diagram of high-level overview of a risk controller process, in accordance with illustrative embodiments, is shown. Risk controller process 500 begins with the creation of risk control matrix 502. Risk control matrix 502 contains the associations and definitions of the potential risks associated with a task combination. Additionally, risk control matrix 502 provides a definition of the action to be taken to deal with the specified risk.

From risk control matrix 502 is generated adjusted separation of duties matrix 504 containing the weighting assigned to specified combinations of tasks. The weighting may be used to aid in the determination of when to perform the action or choose another selection.

Monitor/identify 506 performs an oversight function to determine when a violation of the policy stated in adjusted separation of duties matrix 504 occurs. In addition, sample 508 may be performed on the alerts generated by the monitoring process to reduce the number of events to be reviewed. Sample 508 uses a predefined number of alerts to review rather than all alerts. Report 510 produces a listing of the events or alerts that have been encountered, as well as the action applied. The report may be viewed by a user, sent for review, stored or printed. The report may be examined and used as input to change the definitions and risk assignments.

The potential risk values have been quantified and associated with tasks in adjusted separation of duty matrix 504. The risk values are expressed as positive numbers; the larger the value, the higher the risk indicated. In one embodiment, the risk values are calculated using the process just described.

Risk control matrix 502 is created. Risk control matrix 502 defines potential risks in business processes and the controls (control activities) to deal with such risks. Risk control matrix is a generally-employed concept used ordinarily for purposes other than separation of duties. In an illustrative embodiment, risk control matrix 502 is expressed as a set of risk controls with a set of the following components; purpose of separating duties (prevention of a specific fraud), risk size or value, and set of tasks for which duties should be separated or controlled.

The set of tasks for which duties should be separated or controlled is a set of tasks which should be separated to accomplish the purpose described (such as eliminate fraud), and denotes that a single employee cannot perform all of the tasks in the set of tasks.

Adjusted separation of duties matrix 504 is then generated from risk control matrix 502, and the risk value of each conflict is calculated. Given quantified risk values, assigning each task to employees may be done to ensure the risk is minimized. In addition, the use of quantified risk values also allows for sampling in quantities proportionate to risk values. For example, in the detail view of adjusted separation of duties matrix 504, conflict 518 is the risk of conflict between task A and task B, shown as 10, while conflict 520 is the risk of conflict between task B and task C, shown as a value of 10, and conflict 516 is the risk of conflict between task A and task C, shown as a value 100.

Dealing with a short staff situation and the performance of the identified tasks, the tasks may be reassessed and assigned with accordance to associated risk. When there are only two employees, the employees can be assigned to the tasks in the following three ways: one employee performs task A and task B, and the other employee performs task C. In this case, the risk is 10. One employee performs task B and task C, while the other employee performs task A. In this case, the risk is again 10. One employee performs task A and task C, and the other employee performs task B. In this case, the risk is much larger at 100. Therefore, the recommendation would be for the first or second option to minimize the risk.

With regard to the sampling of the reports of conflict violations between task A, and task B, as opposed to the sampling of the reports of conflict violations between task A and task C, the ratio of the quantities of the sampling should be 1:10. The higher the risk, the more sampling is required. Minimizing risk may then be generalized using the following input; a set of n number of tasks (T1, T2, . . . Tn), an “n×n” separation of duties matrix weighted with the risk values for the input task set (T1, T2, . . . Tn) and “k” number of employees. The risk value of the conflict of the task pair (Ti, Tj) is denoted by Risk (Ti, Tj). Where there is no conflict, the value is 0. The output is a partition of the n number of tasks into “k” subsets of tasks p1, p2, . . . pk, (an assignment of the “n” tasks to the k employees) so as to minimize the following sum of risk values: Σ{1≦x=k}Σ{(Ti,Tj)εpx} Risk(Ti,Tj), where the first summation is formed over variable x, from 1 through k, while the second summation is formed over task pairs (Ti, Tj) in the assignment px, which is the task set assigned to employee “x.” Monitor/identifier 406, and sampler 408 of FIG. 4 (also 506, 508 of FIG. 5) provide a mechanism to minimize the risk associated with task assignments.

This optimization problem for risk minimization is equivalent to the Max k-Cut problem, which is a well-known problem in graph theory. Therefore, known algorithms for solving the Max k-Cut problem can be used to solve the optimization problem.

The details of the method to quantify the risk of each conflict may be described as defining a risk control matrix that is a set of risk controls. Each risk control comprises the following components of a purpose of separating duties, such as the prevention of a specific fraud, a risk size (given as a positive numeral), and a set of tasks for which duties should be separated, such as a set of two or more tasks. The first component is descriptive and expressed in natural language, and thus, does not contribute to the quantifying of risks directly. The risk size (the second component) is generally calculated by multiplying the frequency of occurrence, of the specific fraud in this case, by ensuing losses, although such calculation is outside the scope of the present invention. The third component is a set of tasks for which duties should be separated for the purpose of the first component. If a same employee is allowed to perform all the tasks in the set, the fraud specified in the first component can become a reality. However, if the same employee is prevented from performing at least one of the tasks in the task set, the fraudulent scenario becomes less possible.

Consider a risk control matrix which is made up of m number of risk controls RCM={RC1, RC2, . . . RCm}. The risk size of the “x'th” risk control is denoted by Risk(x). The set of tasks for which duties should be separated in the x'th risk control is denoted by TaskSet(x). The number of tasks in TaskSet(x) is denoted by TaskSetSize(x).

Further consider risk controls such that, given the risk control RCx, the fraud takes place only when the same employee performs all the tasks in TaskSet(x). However, generally, there is also a possibility of a fraudulent scenario such that the fraud takes place even if the same employee performs part of the tasks out of a multiple number of tasks. For example, there is a possibility of some sort of fraud such that it takes place if the same employee is allowed to perform at least two tasks out of the three tasks A, B, and C. The aforementioned framework can still be applied to such a case by dividing the risk control into three different risk controls. That is, all that is required is to consider a risk control of each of the following fraudulent scenarios of: a possible fraudulent scenario when the same employee is allowed to perform the task A, task B pair; another possible fraudulent scenario when the same employee is allowed to perform the task B, task C pair; and another possible fraudulent scenario when the same employee is allowed to perform the task A, task C pair.

Having created a risk control matrix, now generate a separation of duty matrix from the risk control matrix. The risk value of each conflict, associated with a task pair is calculated in two steps: (1) the risk value of every task pair (Ti, Tj) is initialized with 0, for example, Risk(Ti,Tj)=0.(2) for 1≦x≦m and for every task pair (Ti, Tj) in TaskSet(x), calculate Risk(Ti, Tj)=Risk(Ti, Tj)+RiskDistribute(x, Ti, Tj).

That is, to each conflict in the x'th risk control, the risk value calculated by RiskDistribute function is added. In other words, this function expresses how the risk value Risk(x) in the x'th risk control is distributed to each conflict (Ti, Tj).

There are a variety of examples of RiskDistribute functions. A first example is RiskDistribute(x, Ti, Tj)=Risk(x),where the Risk(x) value becomes the risk value of the conflict (Ti, Tj) without change.

A second example is RiskDistribute(x, Ti, Tj)=Risk(x)/(TaskSetSize(x)−1). This function is useful when TaskSetSize(x) is 2 or 3. When TaskSetSize(x) is 2, Risk(x) is distributed to the conflict without change. When TaskSetSize(x) is 3, the Risk(x) arises if the same employee is allowed to perform the three tasks A, B, and C. In other words, the three conflicts (A,B), (B,C), and (A,C) are expressed in the separation of duties matrix, and, when two of the conflicts take place out of the three, the risk x arises. Because the value Risk(x)/2 is distributed to each conflict, the risk value as a result of two conflicts becomes Risk(x) as expected.

A third example is RiskDistribute(x, Ti, Tj)=Risk(x)/C(TaskSetSize(x), 2), where C(TaskSetSize(x), 2) denotes the number of task pairs from TaskSet(x). When given a risk control RCx, the number of conflicts generated from TaskSet(x) is C(TaskSetSize(x), 2). Therefore, this function distributes the risk value Risk(x) to each conflict uniformly in the set TaskSet(x).

A fourth example is RiskDistribute(x, Ti, Tj)=w(Ti, Tj)*Risk(x)/C(TaskSetSize(x), 2), which is an extension of the previous function. The risk value calculated in the previous function is multiplied by a weight w(Ti, Tj) (0≦w(Ti, Tj)≦1). In other words, the risk value is distributed to each conflict non-uniformly according to the weight function. For example, the weight w(Ti, Tj) can be calculated based on the cost of the secondary control of the conflict (Ti, Tj). The secondary control means the type of operation put in place when the same employee is allowed to perform the two conflicting tasks, such as, when the manager regularly verifies the employee's business log to check that no fraud is taking place. Secondary prevention of fraud, for example, if the cost required for the secondary control of the conflict of the task pair (Ti, Tj) is expressed as Cost(Ti, Tj), the weight w(Ti, Tj) for the conflict can be calculated so that conflicts whose secondary control has lower cost will have lower risk values calculated as, w(Ti, Tj)=Cost(Ti, Tj)/Σ{(Ti,Tj)εTaskSet(x)}Cost(Ti,Tj). The summation is over all of the task pairs (Ti, Tj) from TaskSet(x).

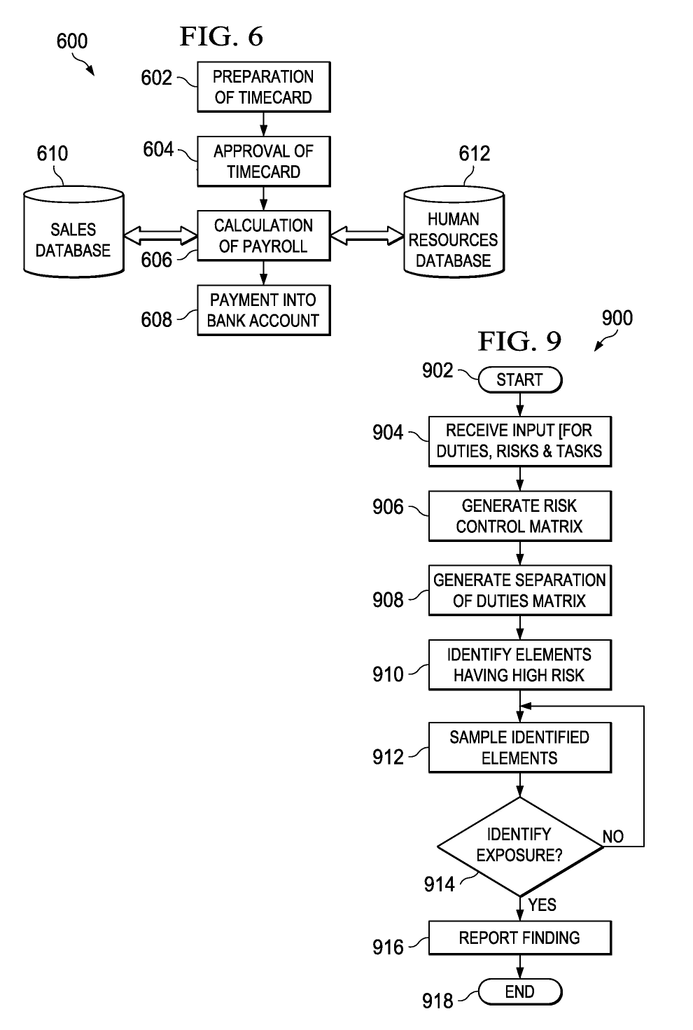

With reference to FIG. 6, is a block diagram of an example of a payroll process, in accordance with illustrative embodiments, is shown. Process 600 is an example of a payroll process, as typically found in a business scenario, in which 6 tasks have been defined and used. The tasks are defined to be: 1. Preparation of Timecard 602, 2. Approval of Timecard 604, 3. Calculation of Payroll 606, 4. Payment into Bank Account 608, 5. Sales Database 610, and 6. HR Database 612, where both represent database management systems.

Preparation of Timecard 602 provides a capability for a general employee to create a time card, then request approval from an immediate manager. Approval of Timecard 604, allows the manager to approve the content of the time card. Calculation of Payroll 606 performs the salary calculation based on the sales database containing each employee's sales record data, and the human resource (HR) database containing information on each employee's position. The higher the sales record and the higher the position, the higher the resulting salary.

Payment into Bank Account 608 provides the mechanism for the salary to be deposited into each employee's bank account. Sales Database Management 610 provides for updates to the data in the sales database, and HR Database Management 612 provides for updates to the data in the HR database.

Definitions based on the fraudulent scenarios in the process of salary payment such as those published in Association of Certified Fraud Examiners (ACFE) Report to the Nation on Occupational Fraud and Abuse for 2006, which may be obtained at http://www.acfe.com/resources/publications.asp?copy=rttn, are examples from which a risk control matrix can be defined.

With reference to FIG. 7, a tabular view of a risk control matrix, in accordance with illustrative embodiments, is shown. Risk control matrix 700 is an example of a table comprising risk control values for payroll process 600 of FIG. 6.

Header 702 provides a column defining the purpose of separating the duties, such as prevention of frauds, in this case. Heading 704 provides an indication of the risk value associated with purpose in the form of a median loss in dollars. Header 706 provides a list of tasks to be separated for each stated purpose. List 714 presents the list of purposes associated with the prevention of frauds main purpose of the table.

Purpose 708 identifies the stated purpose, in this case, to prevent a ghost employee scheme from occurring. Associated risk value 710, identified as being $137,500, indicates the dollar value of the potential risk, should the purpose not be met. Task list 712 indicates the set of tasks to be separated in order to achieve the corresponding purpose in the row.

Risk control matrix 700 is an example based on seven fraudulent scenarios of list 714. The risk value of each fraud is the median value of the losses incurred by that particular fraud, as shown in the column under header 704. In addition, the tasks to be separated in order to prevent each fraudulent scenario are listed in the column under header 706.

Each element in list 714 is explained in order, as a task assigned a letter. (A) Prevent ghost employee scheme, or creation of a new ghost, is defined to prevent an employee registering a fictitious employee into the human resource database to have the resulting salary deposited into the creating user's own account. (B) Prevent ghost employee scheme, is defined to prevent the failure to remove terminated employees upon termination, where an employee fails to remove a retired employee from the human resource database to have the resulting salary deposited into the employee's own account. (C) Prevent falsified hours, is defined to prevent an employee from falsifying a time card. (D) Prevent falsified salary, is defined to prevent an employee from changing their own position recorded in the human resource database to raise their own pay. (E) Prevent commission scheme, such as adding fictitious sales, is defined to prevent an employee from registering a fictitious sales record in the sales database to raise their own pay. (F) Prevent commission scheme, such as overstate sales, is defined to prevent an employee from changing their own sales record in the sales database to raise their own pay. (G) Prevent commission scheme, such as increase rate of commission, is defined to prevent an employee from changing the record in the human resources database so as to raise the percentage at which the employee sales record is reflected to a salary to raise their own pay.

With reference to FIG. 8, a tabular view of an adjusted separation of duties matrix, in accordance with illustrative embodiments, is shown. Adjusted separation of duties matrix 800 is an example of a separation of duties matrix resulting from calculations using resource control matrix 700, of FIG. 7, and input associated with payroll process 600 of FIG. 6.

Elements 802 through 812 identify the respective task numbers from 1 to 6, while list 824 indicates the descriptive names and numbers of the tasks. Element 814 indicates the task of preparation of time. Element 816 represents a value, expressed in thousands of dollars, of $152.5 for the quantified risk of the conflict defined as the combination of task 1 and task 2. Element 820 indicates the risk value of 14 associated with the task combination of task 1 and 5, while element 818 indicates the risk value of 222.5 for the combination of tasks 1 and 6.

The RiskDistribute(x, Ti, Tj)=Risk(x)/(TaskSetSize(x)−1) function previously described is used now as an example. The calculated risk value of each conflict is applied to create an adjusted separation of duties matrix, where the unit of risk is expressed in thousands of dollars. The risk value associated with task 1 and task 2 is the sum of $137,500*½ from the risk control A, $137,500*½ from the risk control B, and $15,000 from the risk control C, for a total of $152,500, as in element 816.

The risk value associated with task 1 and task 5 is the sum of $70,000 from the risk control E, $70,000 from the risk control F, for a sum of $140,000, as shown in element 820. The risk value associated with task 1 and task 6 is the sum of $137,500*½ from the risk control A, $137,500*½ from the risk control B, $15,000 from the risk control D, and $70,000 from the risk control G, for a sum of $225,500, as in element 818. The risk value associated with task 2 and task 6 is the sum of $137,500*½ from the risk control A, and $137,500*½ from the risk control B, for a sum of $137,500, shown in element 822.

Using the separation of duties matrix of FIG. 8, the problem of short-staffing may be handled. In this case, at least three employees are required to prevent the defined separation of duties conflicts. A task assignment example with no violation occurs when there are three employees assigned tasks as: Employee A: Task 1, Task 3, Task 4, Employee B: Task 2, Task 5, and Employee C: Task 6. When there are only two employees, a violation cannot be avoided. For example, in the following three-task assignments, Employee A: Task 1, Task 3, and Task 4, resulting in the sum of risk incurred by Employee A's assignment to be 0 k$. For Employee B: Task 2, Task 5, and Task 6, the resulting sum of risk incurred by Employee B's assignment is then 137.5 k$, and the total risk value is 137.5 k$

In another example, the assignments are changed so that Employee A has Task 1 to Task 6. The sum of risk incurred by Employee A's assignment is calculated as 152.5+14+222.5, for a total of 389 k$. A new assignment for Employee B is no tasks. The sum of risk incurred by Employee B's assignment is therefore 0 k$. The total risk value of this example is now 389 k$.

In another assignment example, Employee A is assigned Tasks 1, 3, 4, 6. The sum of risk incurred by Employee A's assignment is calculated as 222.5 k$. The new assignment for Employee B of Tasks 2, 4, 5 represents a sum of risk incurred by Employee B's assignment of 0 k$, for a new total risk value of 222.5 k$. Therefore, the first assignment example is better than the second and third assignments.

With regard to sampling according to risk to reduce the number of samples needed, it may be shown to be effective for the purpose intended. Again with reference to FIG. 8, the risks of separation of duties violation are listed in the order of high risk from adjusted separation duties matrix 800. Risk of separation of duties violation for Task 1 and Task 6 is 222.5 k$, for Task 1 and Task 2 is 152.5 k$, for Task 2 and Task 6 is 137.5 k$, for Task 1 and Task 5 is 14 k$, and for other combinations of two tasks is 0 k$. Therefore, in the sampling checks, sampling according to the percentage of each risk is shown to be sufficient.

With reference to FIG. 9, a flowchart of a process of defining an adjusted separation of duties matrix, in accordance with illustrative embodiments is shown. Process 900 is an example of using a process as performed by risk controller 400 of FIG. 4 to provide a risk control matrix and an adjusted separation of duties matrix. Process 900 starts (step 902) and receives a set of input data comprising a set of task information and a set of employee information to form received input (step 904). Generating a risk control matrix creates a risk control matrix from the received input (step 906). A risk is associated with each risk control of the risk control matrix. Generating an “n×n” weighted or adjusted separation of duties matrix from the risk control matrix, is performed, wherein (Ti,Tj) represents a task pair, and Risk(Ti,Tj) represents a risk value of a conflict of the task pair (Ti,Tj). Generating a task to employee assignment (p1, p2, p3, . . . pk) such that the expression Σ{1≦x≦k}Σ{(Ti,Tj)εpx} Risk(Ti,Tj) is minimized, wherein “k” represents the number of employees, and “pi” represents a set of tasks assigned to employee “i”(step 908). The first summation is formed over variable x, from 1 through k, while the second summation is formed over task pairs (Tᵢ, Tⱼ) in the assignment px, which is the task set assigned to employee “x.”

From the created separation of duties matrix, identifying elements of high risk in the “n×n” weighted, or adjusted separation of duties matrix; to form identified elements (step 910). Sampling the identified elements to form sampled elements is performed to reduce the resources needed to examine all entries (step 912). Determining whether the sampled elements identify a risk exposure is performed to determine whether risk exposures have been occurred (step 914). When a risk exposure has been determined a “yes” result is obtained in step 914. When no risk exposure has been determined, a “no” result is obtained in step 914. When a “yes” is obtained in step 914, a risk exposure has been identified and a report of a finding of the risk exposure is generated (step 916), with process 900 terminating thereafter (step 918). The generated report may be sent to a requesting user or component by a notifier component. When a “no” result is obtained in step 914, process 900 loops back to step 912.

Illustrative embodiments provide a capability to generate a risk control matrix to associate risks of conflicts among task pairings. The risk values are then used in the generation of weighted or adjusted separation of duties matrices that reflect the quantified risks per task pairing assignments. The quantified risks aid in determining task assignment scenarios having the least cost. Further, the weighted values aid in the sampling required to confirm violations of the separation of duties by indicating that sampling according to risk is, typically, a prudent option.

The flowchart and block diagrams in the figures illustrate the architecture, functionality, and operation of possible implementations of systems, methods and computer program products, according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function, in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention, the practical application, and to enable others of ordinary skill in the art to understand the invention for various embodiments, with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by, or in connection with, a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, or remote printers or storage devices, through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for evaluating risks of conflicts in separation of duties matrices, the computer implemented method comprising:
receiving a set of input data comprising a set of task information and a set of employee information to form received input;
generating a risk control matrix, from the received input, having a risk associated with each risk control of the risk control matrix;
generating an “n×n” weighted separation of duties matrix from the risk control matrix, wherein (Ti,Tj) represents a task pair, and Risk(Ti,Tj) represents a risk value of a conflict of the task pair (Ti,Tj);
generating a task to employee assignment (p1, p2, p3, . . . pk) such that Σ{1≦x≦k}Σ{(Ti,Tj),εpx} Risk(Ti,Tj) is minimized, wherein “k” represents the number of employees, and “pi” represents a set of tasks assigned to employee “i;”
identifying elements of high risk in the “n×n” weighted separation of duties matrix; to form identified elements;
sampling the identified elements to form sampled elements;
determining whether the sampled elements identify a risk exposure; and
responsive to a determination that the sampled elements identify a risk exposure, reporting a finding of the risk exposure.
